(19) United States
(12) Patent Application Publication
(10) Pub. No.: US 2015/0310683 A1
(43) Pub. Date: Oct. 29, 2015

(54) IDENTIFICATION DEVICE, PORTABLE KEY DEVICE, LOCK DEVICE, AND METHOD FOR IDENTIFYING A PORTABLE KEY DEVICE

(71) Applicant: Gael PILARD, Wankheim (DE)

(72) Inventor: Gael PILARD, Wankheim (DE)

(21) Appl. No.: 14/375,084

(22) PCT Filed: Feb. 1, 2013
(86) PCT No.: PCT/EP2013/052091

§ 371 Date: Jul. 28, 2014

(30) Foreign Application Priority Data
Feb. 2, 2012 (DE) 10 2012 201 479.9

(51) Int. Cl. G07C 9/00

(52) U.S. Cl. CPC G07C 9/00174; G07C 9/00857; G07C 2009/00785

(57) ABSTRACT

An identification device includes a portable key device which has a first memory device for storing an associated identifier and a projector device which is configured to project an optical code matrix, which is based on the identifier, as an image, and a lock device which is configured to detect the image of the optical code matrix projected by the projector device via a sensor device, and to carry out an image analysis of the detected image of the optical code matrix via an identification device, and on the basis thereof, to identify the portable key device with the aid of a comparison of the identifier analyzed from the optical code matrix with identifiers stored in a second memory device of the lock device.

### FIELD OF THE INVENTION

The present invention relates to an identification device, portable key device, a lock device, and a method for identifying a portable key device.

### BACKGROUND INFORMATION

German patent document DE 693 32 814 T2 discusses an information system for the optical reading of a dot code which is suitable for recording and/or reproducing so-called multimedia information, including, for example, audio information such as speech information and music information, video information which is received by a camera, a video recorder, or similar devices, and digital code data which are received by a personal computer, a word processor, or similar systems. The information system is capable of reproducing the dot code, which may be read optically, in particular, from paper, various kinds of plastic foils, metal foils, or other foils.

German patent document DE 102 21 785 discusses a ticket and a method for creating and checking such a ticket and a checking device for a ticket, information which represents at least a portion of the ticket data being applied on a carrier. The information is applied on the ticket in an encrypted manner within a two-dimensional encryption area whose outer dimensions are firmly predefined. The encryption is configured in such a way that the information is readable in a visually observable manner with the aid of a checking device, the checking device having a firmly predefined, two-dimensional decryption area which is constant over a predefined time unit. The decryption area has essentially the same dimensions as the encryption area, the decryption area being readable via the encryption area for reading out the information, portions of the encryption area and the decryption area being simultaneously perceptible when they are superimposed.

### SUMMARY OF THE INVENTION

The present invention provides an identification device having the features described herein, a portable key device having the features described herein, a lock device having the features described herein, and a method for identifying a portable key device having the features described herein.

An identification device having a portable key device is defined in Patent Claim 1 which has a first memory device for storing an associated identifier and a projector device which is configured to project an optical code matrix, which is based on the identifier, as an image. The identification device furthermore includes a lock device which is configured to detect the image of the optical code matrix projected by the projector device via a sensor device, and to carry out an image analysis of the detected image of the optical code matrix via an identification device, and on the basis thereof, to identify the portable key device with the aid of a comparison of the identifier analyzed from the optical code matrix with identifiers stored in a second memory device of the lock device.

A portable key device is defined herein having a first memory device for storing an associated identifier and having a projector device which is configured to project an optical code matrix, which is based on the identifier, as an image.

A lock device is defined herein having a sensor device for detecting a projected image of an optical code matrix and an identification device for carrying out an image analysis of the detected image of the optical code matrix, the lock device being configured to identify a portable key device on the basis thereof, with the aid of a comparison of the identifier analyzed from the optical code matrix with identifiers stored in a second memory device of the lock device.

A method for identifying a portable key device is defined herein which has a first memory device for storing an associated identifier and a projector device, having the steps of: projecting an optical code matrix, which is based on the identifier of the portable key device, as an image on a projection surface via the projector device, and detecting the image of the optical code matrix projected by the projector device via a sensor device, and carrying out an image analysis of the detected image of the optical code matrix via an identification device, and identifying the portable key device with the aid of a comparison of the identifier analyzed from the optical code matrix with identifiers stored in a second memory device of the lock device.

The present invention is intended to ensure a manipulation-proof identification of a key device.

The idea underlying the present invention is that an identification and authentication of a key device is carried out based on optical code transmission by imaging and detecting an encoded optical light point matrix. The encoded optical light point matrix is produced by the key device of the user to be identified, which is configured as a portable hardware component.

The idea of the present invention provides for transmitting the data to be transmitted for identification in a purely optical manner, instead of the magnetic-strip technology used otherwise or instead of using radio data transmission.

Unlike the magnetic-strip technology, the optically imaged code is thus available in a form which is only briefly readable by third parties. The limited spatial transmission of the data to be transmitted is advantageous in comparison to radio data transmission.

Advantageous specific embodiments and refinements result from the subclaims and from the description with reference to the figures.

According to one advantageous refinement of the identification device, the projector device is configured as an optical electromechanical microsystem, MEMS, or as an LCOS system. It is thus possible to ensure, for example, that the projector device may be integrated into the portable key device.

According to another advantageous refinement of the identification device, the identification device is configured to carry out an access control of a person who carries the portable key device. This enables a simple check of access authorizations for a certain group of people.

According to another advantageous refinement of the identification device, an access of the person to areas approved for that person is controllable via the access control.

According to another advantageous refinement of the identification device, the optical code matrix is configured as a two-dimensional barcode. This allows a simple encoding of the identifier and a reliable image analysis with the aid of methods implemented in the identification device for correcting possible distortions of the optical code matrix.

According to another advantageous refinement of the identification device, the optical code matrix is configured as a two-dimensional matrix having individual data points.

According to another advantageous refinement of the identification device, an individual data point of the optical code matrix has, as an encoding parameter, a light intensity and/or a spectral composition of a light beam bundle which generates the particular data point as an image. This increases the data volume of the useful information transmitted by the optical code matrix, thus also increasing the reliability of the identification and authentication due to the increased data volume or the increased key length of the identifier.

According to another advantageous refinement of the identification device, an individual data point of the optical code matrix is defined by a certain position of one or multiple deflecting mirrors of the projector device.

According to another advantageous refinement of the identification device, the optical code matrix is configured as a 10×10 matrix, which may be a 9×5 matrix, particularly which may be a 2×4 matrix.

The advantages described in the preceding paragraphs are also ensured in a corresponding method for identifying a portable key device.

Additional features and advantages of the present invention are described below based on the attached figures.

### BRIEF DESCRIPTION OF THE DRAWINGS

FIG. 1 shows a schematic representation of the identification device according to one possible specific embodiment of the present invention.

FIG. 2 shows a schematic flow chart of one method for identifying a portable key device according to another possible specific embodiment of the present invention.

FIG. 3 shows a schematic representation of an optical code matrix according to another possible specific embodiment of the present invention.

### DETAILED DESCRIPTION

In the figures of the drawings, identical reference numerals refer to identical or functionally identical components, unless otherwise indicated.

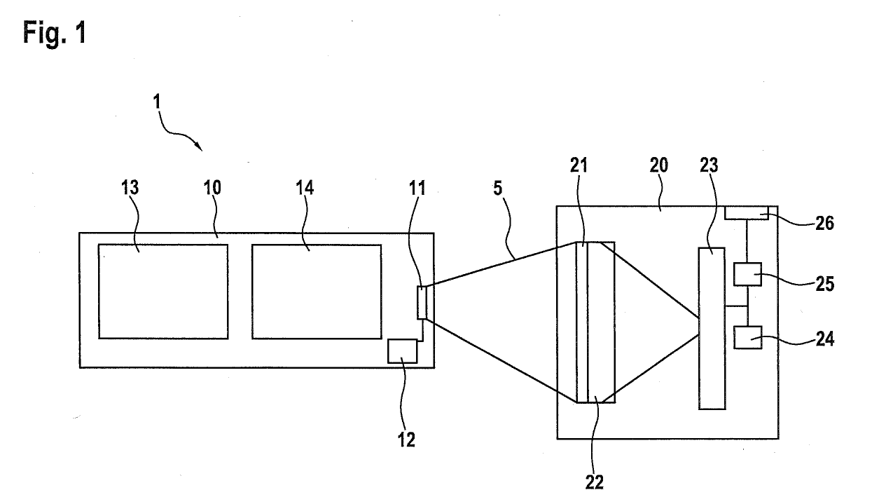

FIG. 1 shows a schematic representation of the identification device according to one possible specific embodiment of the present invention.

An identification device 1 includes a portable key device 10 and a lock device 20.

Portable key device 10 has a first memory device 12 for storing an associated identifier, and a projector device 11.

Projector device 11 is configured to project an optical code matrix 5 based on the identifier of key device 10 as an image in a light cone 5 onto projection surface 21 of lock device 20. A DLP (digital light processing) projector having a digital micromirror device (DMD) may be used as a projector device 11, projector device 11 having an integrated circuit and tilting mirrors which are tiltable via electrical impulses.

Projector device 11 is, for example, configured as an optical electromechanical microsystem, MEMS, or as a digitally controlled micromechanical small-mirror system, or as a liquid crystal on silicon system, LCOS system for short. An LCOS system refers to a system having liquid crystals on a silicon substrate and constitutes a technology for display devices capable of projection with the aid of reflection, similarly to a liquid-crystal display (LCD).

The image generation occurs via a targeted control of the tilting mirrors of projector device 11, so that the light of light cone 5 is conducted or deflected in a desired direction with the aid of a projection lens of projector device 11.

Furthermore, portable key device 10 has an input device 13 and an output device 14. Input device 13 may be configured as a keyboard and is, for example, provided for inputting or selecting an identifier.

Output device 14 may be configured as a screen or display and is, for example, provided for displaying a successful identification of key device 10.

Lock device 20 includes a projection surface 21, a sensor device 22, 23, an identification device 24, a second memory device 25, and an interface device 26.

Projection surface 21 is, for example, configured as a flat surface which is configured transmissively or transflectively and on which the image of optical code matrix 5 is created via projection. A reflection into lateral, undesirable directions may be avoided in order to make a detection of optical code matrix 5 outside of lock device 20 by third parties difficult or impossible.

Sensor device 22, 23 is, for example, configured as an image sensor for recording two-dimensional images electrically using an upstream objective unit. The upstream objective unit is, for example, configured as an objective or another collecting optical system which produces the image on the image sensor of optical code matrix 5 which is projected onto projection surface 21.

Lock device 20 is configured to detect the image of optical code matrix 5 projected by projector device 11 via a sensor device 22, 23, and to carry out an image analysis of the detected image of optical code matrix 5 via an identification device 24, and on the basis thereof, to identify portable key device 10 with the aid of a comparison of the identifier analyzed from optical code matrix 5 with identifiers stored in second memory device 25 of lock device 20.

Identification device 24 is, for example, configured to detect and correct a distortion of optical image matrix 5 caused by the projection.

Interface device 26 is, for example, configured as a radio or plug-connection interface and is used for the communication of lock device 20 with a network. For example, one of the key devices.

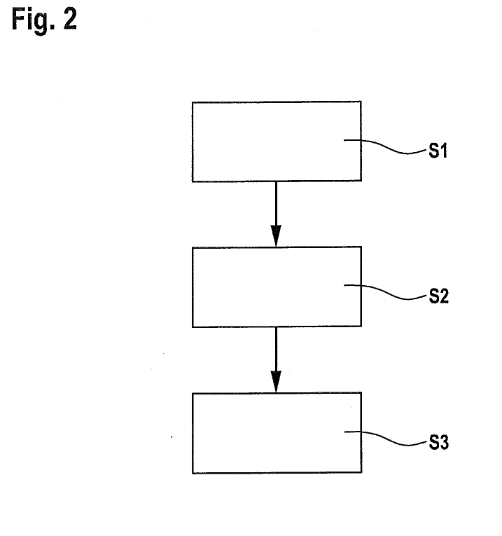

FIG. 2 shows a schematic flow chart of a method for identifying a portable key device according to another possible specific embodiment of the present invention.

In a first step, projector device 11 projects S1 an optical code matrix 5, which is based on the identifier of portable key device 10, as an image onto a projection surface 21. The identifier has, for example, been associated with portable key device 10 by lock device 20 and is stored in memory device 12 of key device 10. One identifier may also be associated with multiple key devices 10.

In a second step, the image of optical code matrix 5 projected by projector device 11 is detected S2 via a sensor device 22, 23 of lock device 20, and an image analysis is carried out of the detected image of optical code matrix 5 via an identification device 24 of lock device 20.

In a third step, portable key device 10 is identified S3 with the aid of a comparison of the identifier analyzed from optical code matrix 5 with identifiers stored in a second memory device 25 of lock device 20. The identifier associated with portable key device 10 and optical code matrices 5 based thereon are stored in second memory device 25.

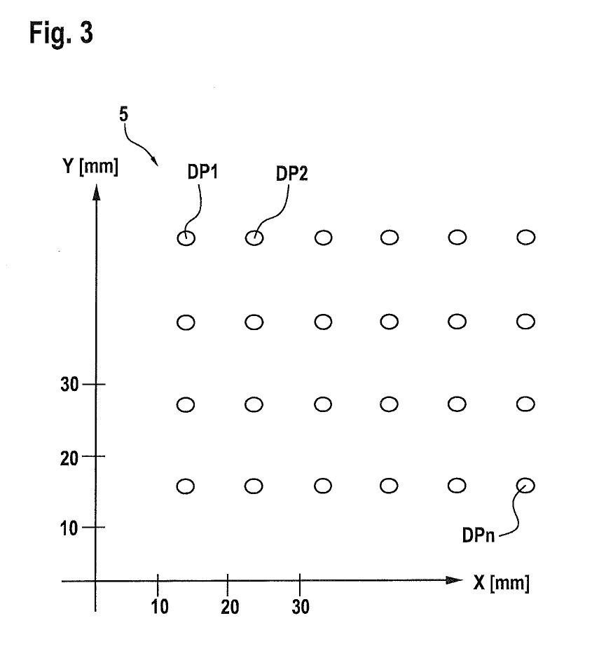

FIG. 3 shows a schematic representation of an optical code matrix according to another possible specific embodiment of the present invention.

Optical code matrix 5 is imaged on projection surface 21 via projector device 11 and is, for example, configured as a two-dimensional matrix having individual data points DP1 through DPn, the X- and Y-axes of the diagram shown in FIG. 3 depicting the imaging dimensions of the image of optical matrix 5. As shown in FIG. 3, optical code matrix 5 has dimensions in the centimeter range.

One single data point DPx of optical code matrix 5 has, as an encoding parameter, a light intensity and/or a spectral composition of a light beam bundle which images the particular data point DPx.

Optical code matrix 5 is, for example, configured as a two-dimensional code or a two-dimensional barcode and represents an optoelectronically readable encoding technology. Various color values and intensity values of the individual data points DP1 through DPn of the two-dimensional code may be used as useful information. The advantage which may thus be achieved is a higher density of useful information which is able to be accommodated per unit of surface area. Optical code matrix 5 is, for example, configured as a 10×10 matrix having 100 data points DPx or as a 9×5 matrix having 45 data points DPx or as a 2×4 matrix having 8 data points DPx.

For example, eight data bits are already defined per data point DPx via a simple encoding of the color value of each data point DPx in a maximum or a minimum intensity of the basic colors red, green and blue, since eight different color values result through the two possible intensity values of the three basic colors. An optical code matrix 5 configured as a 2×2 matrix having such a color value encoding with eight possible color values achieves 4096 different possible encodings of optical code matrix 5.

Even low resolution modes of computer graphics standards which are used in projector device 11 and/or sensor device 22, 23 are therefore suitable for attaining a high number of encoding possibilities.

1-12. (canceled)

13. An identification device, comprising:
a portable key device having a first memory device for storing an associated identifier and a projector device to project an optical code matrix, which is based on the identifier, as an image; and
a lock device to detect the image of the optical code matrix projected by the projector device via a sensor device, and to carry out an image analysis of the detected image of the optical code matrix via an identification device, and on the basis thereof, to identify the portable key device with the aid of a comparison of the identifier analyzed from the optical code matrix with identifiers stored in a second memory device of the lock device.

14. The identification device of claim 13, wherein the projector device includes one of an optical electromechanical microsystem, a MEMS system, and a an LCOS system.

15. The identification device of claim 13, wherein the identification device is designed to carry out an access control of a person who carries the portable key device.

16. The identification device of claim 15, wherein an access of the person to areas approved for that person is controllable via the access control.

17. The identification device of claim 13, wherein the optical code matrix includes a two-dimensional barcode.

18. The identification device of claim 13, wherein the optical code matrix includes a two-dimensional matrix having individual data points.

19. The identification device of claim 13, wherein an individual data point of the optical code matrix has, as an encoding parameter, a light intensity and/or a spectral composition of a light beam bundle which generates each data point as an image.

20. The identification device of claim 13, wherein an individual data point of the optical code matrix is defined by a certain position of one or multiple deflecting mirrors of the projector device.

21. The identification device of claim 13, wherein the optical code matrix includes a 10×10 matrix.

22. A portable key device, comprising:
a first memory device for storing an associated identifier; and
a projector device to project an optical code matrix, which is based on the identifier, as an image.

23. A lock device, comprising:
a sensor device to detect a projected image of an optical code matrix; and
an identification device to carry out an image analysis of the detected image of the optical code matrix;
wherein the lock device is configured to identify a portable key device on the basis thereof with the aid of a comparison of the identifier analyzed from the optical code matrix with identifiers stored in a second memory device of the lock device.

24. A method for identifying a portable key device having a first memory device for storing an associated identifier and a projector device, the method comprising:
projecting an optical code matrix, which is based on the identifier of the portable key device, as an image on a projection surface via the projector device;
detecting the image of the optical code matrix projected by the projector device via a sensor device, and carrying out an image analysis of the detected image of the optical code matrix via an identification device; and
identifying the portable key device with the aid of a comparison of the identifier analyzed from the optical code matrix with identifiers stored in a second memory device of the lock device.

25. The identification device of claim 13, wherein the optical code matrix includes a 9×5 matrix.

26. The identification device of claim 13, wherein the optical code matrix includes a 2×4 matrix.
